(19) United States
(12) Patent Application Publication
(10) Pub. No.: US 2007/0078926 A1
(43) Pub. Date: Apr. 5, 2007

(54) Multimedia system

(75) Inventors: Kai-Chen Tien, Changhua City (TW); Ming-Hui Chen, Banciao City (TW); Ling-Ling Cheng, Taipei City (TW); Ho-Ching Huang, Kaohsiung City (TW); Kuo-Yang Cheng, Taipei City (TW); Kun-Huang Hsu, Shulin City (TW)

Correspondence Address: REED SMITH LLP, Suite 1400, 3110 Fairview Park Drive, Falls Church, VA, 22042, US

(73) Assignee: Inventec Corporation

(21) Appl. No.: 11/242,041

(22) Filed: Oct. 4, 2005

(51) Int. Cl. G06F 15/16

(52) U.S. Cl. 709/203

(57) ABSTRACT

A multimedia system is provided. The multimedia system relates to a main frame and at least a portable display device to proceed with transmission and communication. The portable display device includes a display module to display multimedia digital data, an image decoding module to receive and send a multimedia digital data, and a peripheral control module to select and control multimedia digital data. The wireless module is through many-to-one wireless two-way transmission to receive and send digital signals delivered by the wireless module of the main frame. The main frame not only has general computer's functions but also has multifunctional uses of digital TV playing, web surfing, disk playing, wireless transmission and so on. The portable display device has characteristics of light weight and easy to carry. Through the main frame to proceed with wireless transmission, it will not be limited by wiring distance.

### BACKGROUND OF THE INVENTION

1. Field of the Invention

This invention generally relates to a multimedia system, and in particular relates to a wireless transmission main frame and a portable display device.

2. Related Art

With technology's development, people are paying more and more attention on enhancing the quality of life. Multimedia devices hence come with the tide of fashion. With computer's popularity, broadband network users' and home network permeated rate increase, people through computers and networks carry out the data's transmission and communication. Because wireless broadband transmission can download with speed of 100 M bit/s, this transmission speed can proceed generally called image exchange. Its effect displayed on screen tableau can be 1024×768 pixels, so that multimedia audio-video content sharing can be achieved in home.

And currently a general family has various multimedia devices such as: television (TV), personal computer (PC), notebook (NB) and so on. Generally speaking, no matter it is a personal computer, notebook or television, in order to work normally, they need to have at least the following objects: a main frame, a screen and an external wiring. According to conventional knowledge, personal computer's display is separate from a main frame and has to be wired externally to make it work.

Due to wiring source site's and length's limitation, the screen has to be close to a main frame. Therefore, it causes a certain limitation on a screen's placement. Its distance is limited by wiring that causes the incapability to provide multimedia information with a longer distance transmission function. Although the notebook has a portable convenience, its screen and main frame are combined together and can not be separated. Therefore, it can only base on one-on-one to counter individual usage. It cannot provide general families the need of watching different programs. Further, traditional televisions are bulky and heavy, limited by wiring distance and needed to be connected with wires, and also not suitable to move. All these drawbacks added, furthermore, fails to conform to portable convenient need. From the foregoing, this invention is to improve the above-mentioned defects that have a lot of space for improvement and advancement.

### SUMMARY OF THE INVENTION

The object of this invention is to let user's home portable display devices can proceed with wireless transmission through a main frame to solve a wired display device's defects that it is limited by a wiring distance and not separated from a main frame.

In order to achieve the object, this invention provides a multimedia system which at least includes: a main frame and at least a portable display device; a main frame is through wireless transmission of one to many separately to connect and correspond with display devices. A display device can apply and collocate with a main frame and both can be separately alone or integrate together. A main frame can be any computer platform. A display device is portable to enable users at any place in the home to enjoy multimedia programs through a peripheral control module or touch control panel to choose the favorite programs to watch.

The fundamental framework of a multimedia system of this invention at least includes a main frame and at least a portable display device to processing transmission and communication. A main frame and a portable display device are through wireless transmission of one to many to connect with each other separately. A main frame has not only functions of a general computer but also functions of digital television playing, web surfing, DVD playing, data storing, and radio listening and so on. Its portable display device has the characteristics of light and easy to carry. To move a display device has no need to move a main frame. The external wirings are all set on a main frame. A portable display has no need for any extra wiring then can through a main frame to process transmission and communication. There's no wiring distance limitation between the two and it's suitable for a general family application.

Therefore, this invention's multimedia system is applicable to solve the conventional defects. It can not only achieve fine vision and hearing effect but also can transmit a distance as far as about 30 meters by wireless transmission. The display device has no need to have any extra wiring. All the wirings are set on a main frame. This will conform to general families' need of convenience. Besides, when the portable display device is moved, it is no need to move the main frame. People can watch any program at any place in the house and further the portable device can combine with the main frame, so the invention can save space and money. The main frame does not have any limitation in space. Therefore, it will not cause any problem of design limitation due to heat radiation, convection and so on. The display device provides a multimedia display function and supports multiform multimedia digital data and has high compatibility. Further, the main frame has a one-to-many two-way wireless transmission function. Thus, it can correspond with the operation of a display device and further increases the capacity.

The following is through the preferred embodiment to illustrate an embodiment of this invention. One skilled in the art can through the proclaimed contents of this description easily understand this invention's other advantages and merits. It will be obvious that the same may be varied in many ways. Such variations are not be regarded as a departure from the spirit and scope of the invention, and all such modifications as would be obvious to one skilled in the art are intended to be included within the scope of this invention. In order to let this invention's mentioned objects, features and advantages more obvious and easy to be understood, the following description provides a preferred embodiment and with correspondent illustrations of the attached describe more in details as follows.

### BRIEF DESCRIPTION OF THE DRAWINGS

FIG. 1 is an application descriptive view of a multimedia system of a preferred embodiment;

FIG. 2 is a framework descriptive view of a multimedia system of the preferred embodiment; and

FIG. 3 is a three-dimensional descriptive view of a portable display device of the preferred embodiment.

### DESCRIPTION OF THE PREFERRED EMBODIMENT

To embody this invention's features and advantages, some of the typical preferred embodiment will be described in details at the latter part of this description. It's obvious that the same may be varied in many ways. Such variations are not to be regarded as a departure from the spirit and scope of the invention, and all such modifications as would be obvious to one skilled in the art are intended to be included within the scope of this invention.

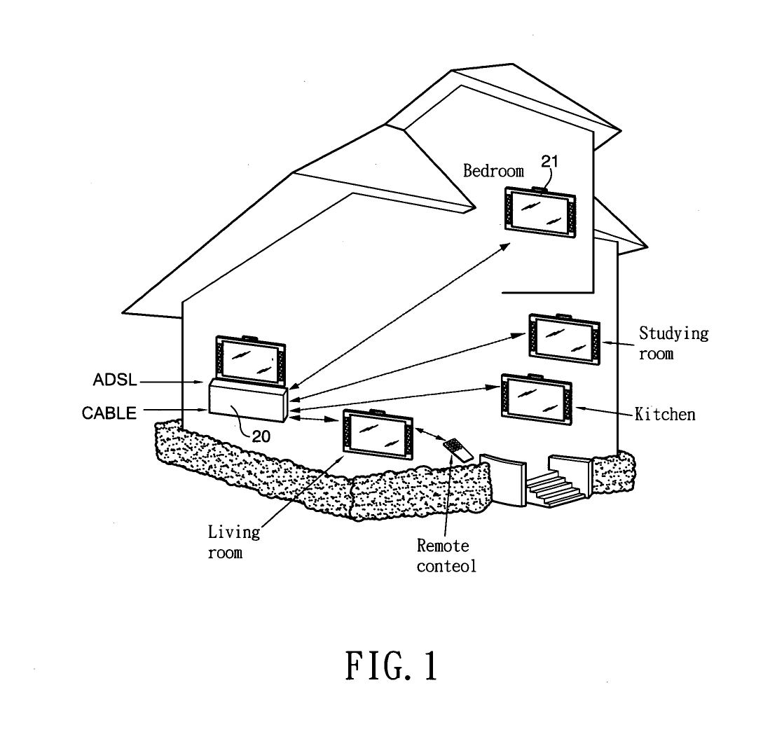

FIG. 1 is an application descriptive view of a multimedia system of this invention's preferred embodiment. A multimedia system includes a main frame 20 and at least a portable display device 21. In this embodiment, the multimedia system is applicable to home life for watching multimedia programs. Family members can watch their own favorite programs at any place in the house such as in bedrooms, a kitchen, or a living room at the same time and will not conflict with others of watching favorite programs. Because the display device is portable, people can watch their own favorite programs at any place in their house. The main frame 20 and the portable display device 21 can be stood alone or integrate together with a one-to-many working mode to proceed a two-way transmission through a wireless module. The transmission mode is to use any of the wireless technique protocol of IEEE 802.11a, 802.11b, 802.11g or 802.11n and so on to process. The main frame 20 can be any computer platform such as a server. The display device is portable and can let users at any place in the house to choose their own favorite programs through a peripheral control module or touch control panel.

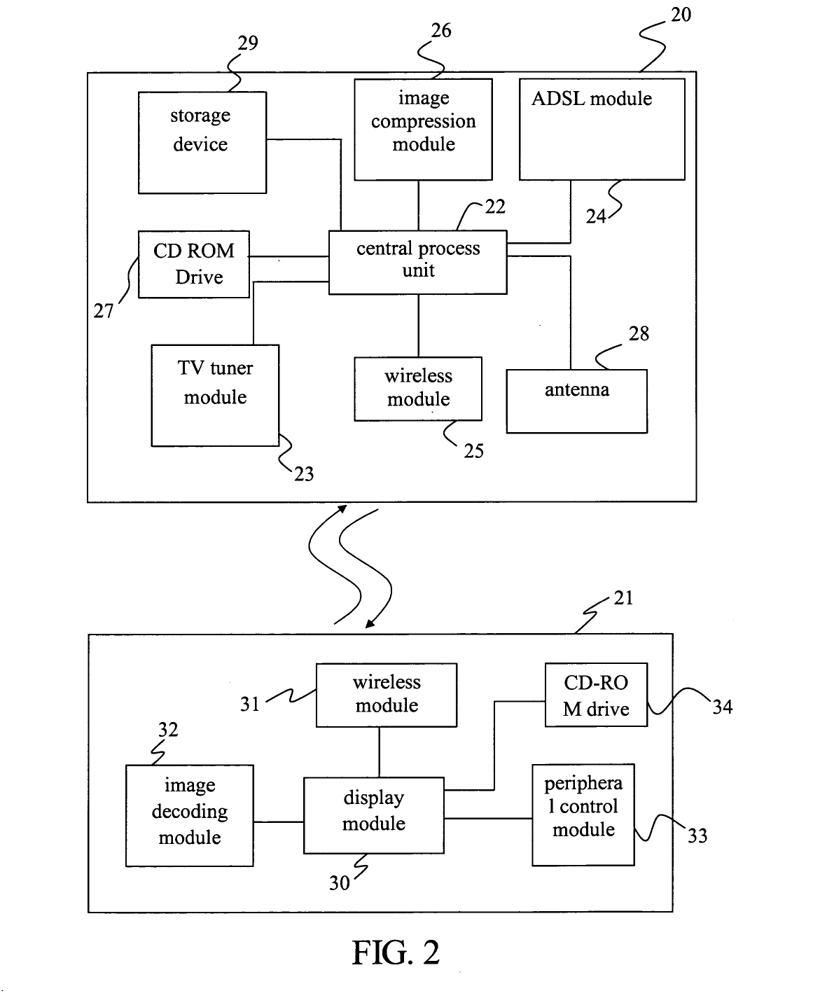

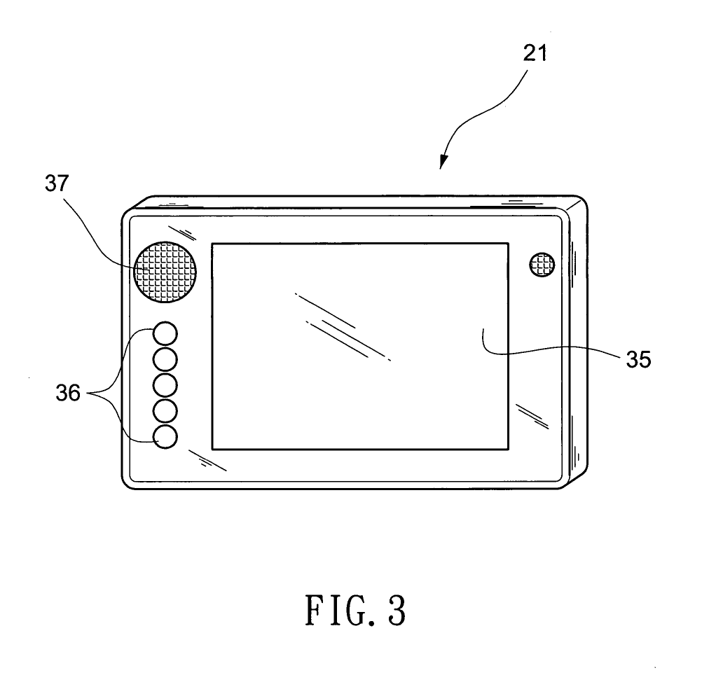

FIG. 2 is a framework descriptive view of a multimedia system of this invention's embodiment. A main frame 20 includes a central process unit (CPU) 22 to process and calculate multimedia digital data; a TV tuner module (embedded TV tuner) 23, having a video tuner function; an Asymmetric Digital Subscriber Line (ADSL) module 24, having a internet connecting function; at least a wireless module 25, having a one-to-many two-way wireless transmission function to receive or deliver any received and sent signal of a wireless module 31 of a portable display device 21; an image compression module 26, compressing image video-information to needed bandwidth, which processed by a central process unit 22, and delivered by a wireless module 25 to the portable display device 21 to display; a CD-ROM drive 27, used to play VCD or DVD; the main frame 20 can connect with an antenna 28 to receive high definition digital TV programs or digital radio; a storage device 29, used to store multimedia digital data. The portable display device 21 includes a display module 30, used to display multimedia digital data; a wireless module 31, used to receive or deliver any received and sent signal of the wireless module 25 of the main frame 20; an image decoding module 32, receiving any received and sent signal of the wireless module 31, having a many-to-one two-way wireless transmission function to proceed decoding and editing process of a multimedia digital data; and a peripheral control module 33, used to select and control multimedia digital data, that a peripheral control module 33 can be any transmission interface control device of infrared rays, wireless or Bluetooth (such as keyboard, mouse or mobile controller); a CD-ROM drive 34, used to read and write multimedia digital data into a disk. It can be a selected outfit, as it can be played by the display device 21 without through the main frame 20. FIG. 3 is a three-dimensional descriptive view of a portable display device. A portable display 21 can be a liquid crystal display (LCD) device. An LCD device includes a touch control panel 35, which can facilitate selection when mouse is not in use; a function key (hot key) 36, which is convenient to users to directly select a multimedia digital data; a multimedia speaker 37, playing audio signals of a multimedia digital data; a hidden stand (not shown in the FIGS.), used to support an LCD display device; a charger (not shown in the FIGS.), connected directly with the main frame for recharging; a battery (not shown in the FIGS.), supplying power to the LCD only so that the power of the battery can last longer. To move the display device 21 has no need to move the main frame 20. The display device 21 can integrate with the main frame 20 to have general computer's functions. It has characteristics of light weight, big size, and portable.

This invention is to combine wireless networking transmission technique with a portable display device together. A main frame is placed at a corner in a house and connects with outdoor ADSL or CABLE network. Through the main frame processes multimedia digital data to present video-sound effect on a portable display. Because the display has a portable convenience, it can be watched at any place in the house, so that it can satisfy general family's multiple and convenience requirements about multimedia digital video and audio.

Thus it is obvious, this invention takes advantage of separable and combinative of both a main frame and a portable display device, that really achieve the improvement of the conventional technique which has defects of incapable to move and not easy to carry. It is suitable for a family use and a main frame has no need to be light weight and compact, so there's no space design limitation problem due to heat radiation and so on. Its external wirings all are set on the main frame, so the display device has no need to have extra wirings.

A display device is portable. Through a main frame, it processes transmission and communication. There's no wiring distance limitation and is suitable for general families' need.

As mentioned above, this invention's wireless multimedia system can provide a one-to-many wireless transmission function and will not be limited by wiring distance that to proceeds with two-way transmission and communication to satisfy the need of a general family to watch different programs individually. And a hard disk drive can be a storage medium for multimedia digital data.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A multimedia system, comprising:
a main frame, wherein the main frame comprising a central process unit, a TV tuner module, an asymmetric digital subscriber line module, at least a wireless module, an image compression module; and
a portable display device, wherein the portable display device further comprising:
a display module to display multimedia digital data;
an image decoding module to process decoding and editing of the multimedia digital data;
a wireless module to receive and send the multimedia digital data; and
a peripheral control module to select and control the multimedia digital data,
wherein the wireless module of the portable display device has a many-to-one two-way wireless transmission function for receiving and sending digital signals delivered by the wireless module of the main frame.

2. The multimedia system according to claim 1, wherein the main frame further comprises an antenna, to receive signals of digital television and radio.

3. The multimedia system according to claim 1, wherein the portable display device is a liquid crystal display device.

4. The multimedia system according to claim 1, wherein the wireless module is to process via wireless technique protocol of IEEE 802.11a, 802.11b, 802.11g and 802.11n.

5. The multimedia system according to claim 1, wherein the peripheral control module is one of infrared ray, wireless, and Bluetooth peripheral control device.

6. The multimedia system according to claim 1, wherein the main frame further comprises a CD-ROM drive to read or write into a disk.

7. The multimedia system according to claim 1, wherein the portable display device further comprises a CD-ROM drive.

8. The multimedia system according to claim 1, wherein the main frame further comprises a storage device to store the multimedia digital data.

9. The multimedia system according to claim 5, wherein the peripheral control module further comprises a function key to facilitate users selecting a multimedia digital data.

10. The multimedia system according to claim 3, wherein the liquid crystal display device further comprises a touch control panel.
